(19) United States
(12) Patent Application Publication
(10) Pub. No.: US 2012/0193910 A1
(43) Pub. Date: Aug. 2, 2012

(54) Flanged Spool With Pull Collar

(75) Inventors: Kevin Vice, Youngsville, LA (US); Shazam Rahim, Broussard, LA (US)

(73) Assignee: PROFESSIONAL WIRELINE RENTALS, LLC, Broussard, LA (US)

(21) Appl. No.: 13/197,063

(22) Filed: Aug. 3, 2011

Related U.S. Application Data
(60) Provisional application No. 61/370,551, filed on Aug. 4, 2010.

(51) Int. Cl. F16L 23/00

(52) U.S. Cl. 285/408

(57) ABSTRACT

An elongated, hollow spool has end flanges and a recessed section between the end flanges. The spool may be attached to an flange atop a tubular member, and other equipment may be attached to the top of the spool. A pull collar, typically of two substantially identical half circle pieces, fits around the intermediate section and is pinned together. The collar can then rotate around the spool, but is longitudinally restrained. Attachment lugs formed in the collar permit attachment of securing members, to run to anchor points, or to fasten to other equipment to stabilize same.

### CROSS REFERENCE TO RELATED APPLICATIONS

This United States regular patent application claims priority to U.S. provisional patent application Ser. No. 61/370,551, filed Aug. 4, 2010, for all purposes.

### BACKGROUND

Frequently, in connection with the drilling and/or servicing of wells, namely oil and gas wells, a top flange is installed on an upwardly standing tubular or riser. Depending upon the particular work being done on the well, various types of equipment may need to be mounted on the flange.

For safety and other reasons, it is frequently necessary to stabilize the tubular and minimize its back-and-forth movement. In addition, it may be desirable to secure and stabilize equipment which is mounted atop the flange. For multiple reasons, then, it is frequently necessary and/or desirable to attach lines or cables to the tubular and/or the equipment mounted on the flange, which can be attached to stabilizing, guy, or anchor points to provide a stabilizing force to the tubular and the equipment.

Prior art methods included connecting points in the nature of connecting eyes welded to the tubular. This obviously poses issues with welding in dangerous environments, etc. Further, the fixed connection points cannot rotate so as to align the pull of the stabilizing cables with the center of the tubular; in the event that the cables are not so aligned, a torque is applied to the tubular (and all things connected with it). This is undesirable. Other prior art methods included connecting points welded or bolted to the flange, or having the cables simply looped around the flange or the equipment mounted thereon. This last option presents potential problems with the cables slipping down out of position.

### SUMMARY OF THE INVENTION

The present invention relates to an apparatus which is connected to a flange structure, such as a wellhead, to provide a secure base for attaching securing cables and the like, other equipment or tools. While various structures are possible within the scope of the invention, one embodying the principles of the present invention is an elongated hollow spool having upper and lower end flanges, with an intermediate enlarged area or flange positioned between the upper and lower flanges. An intermediate cylindrical recessed section, with a diameter small than that of the end flanges and any intermediate flange, is thereby formed between the intermediate flange and one of the end flanges. A pull collar, typically of two half-circle halves, is attached to the spool, by encircling the spool around a recessed section and being fastened together, typically by pins inserted through mating holes in ears on the pull collar halves. The pull collar, while fitting snugly around the spool, is able to easily rotate on the spool. A pair of lugs are connected to or formed in the pull collar, on opposing sides, to provide secure points for attachment of securing members, which may be cables, ropes, rigid members, etc. The pull collar can rotate on the spool in response to forces from the securing members.

### BRIEF DESCRIPTION OF THE DRAWINGS

FIG. 1 is a perspective view of the apparatus of the present invention, a flanged spool with pull collar.

FIG. 2 is a side view of the invention.

FIG. 3 is a more detailed view of the flanged spool component.

FIG. 4 is a cross section view of the flanged spool component.

FIG. 5 is a perspective view of one half of the pull collar, the other half being identical in shape.

FIG. 6 is an illustration of one application of the present invention.

### DETAILED DESCRIPTION OF ONE EMBODIMENT OF THE INVENTION

The present invention comprises a flanged spool with a pull collar, namely an encircling, removable collar, which preferably includes multiple tiedown points for securing members such as cables and the like. The collar is of multiple pieces so that it can be opened up, placed around the spool, then secured in a closed position (by pins or other devices). The collar can rotate on the spool. The term “cable” herein is used in its broadest form, to include metallic and non-metallic cables, ropes, or similar flexible members, and “securing members” includes all of these flexible members in addition to rigid members such as beams, rods, etc.

With reference to the drawings, one presently preferred embodiment will now be described. The flanged spool with pull collar 10 comprises an elongated hollow spool 20, preferably with end flanges 30 on either end. As is well known in the relevant art, end flanges 30 typically have multiple holes 32 around their perimeter, to permit apparatus 10 to be attached to another flanged component via threaded bolts and nuts. As can be seen in FIG. 4, some of holes 32 may completely penetrate the flange, while others may penetrate only part way through the flange and be threaded. It is understood that either configuration may be used. Typically, and as well known in the relevant art field, the outer faces of end flanges 30 will also have seal ring grooves (only one of which is labeled), into which a steel seal ring is placed when the apparatus is bolted to another flanged component. In addition, in the preferred embodiment shown, spool 20 further comprises an intermediate flange 31, which forms upper and lower recessed sections 33 and 34 between the flanges (see FIG. 4), the recessed sections having a smaller diameter than the flanges. It is understood that spool 20 may comprise only end flanges 30, with no intermediate flange 32; in that case, there is only a single recessed section between end flanges 30.

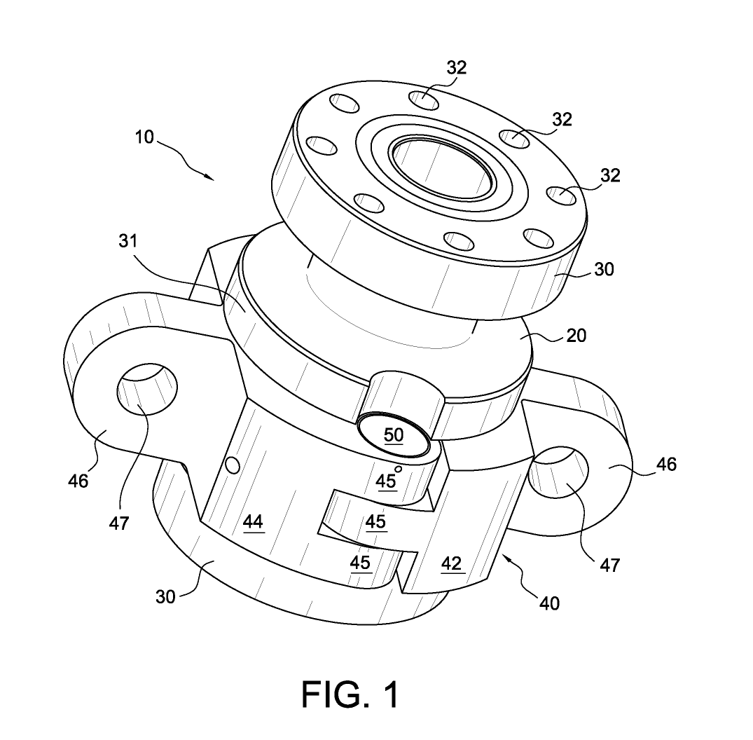

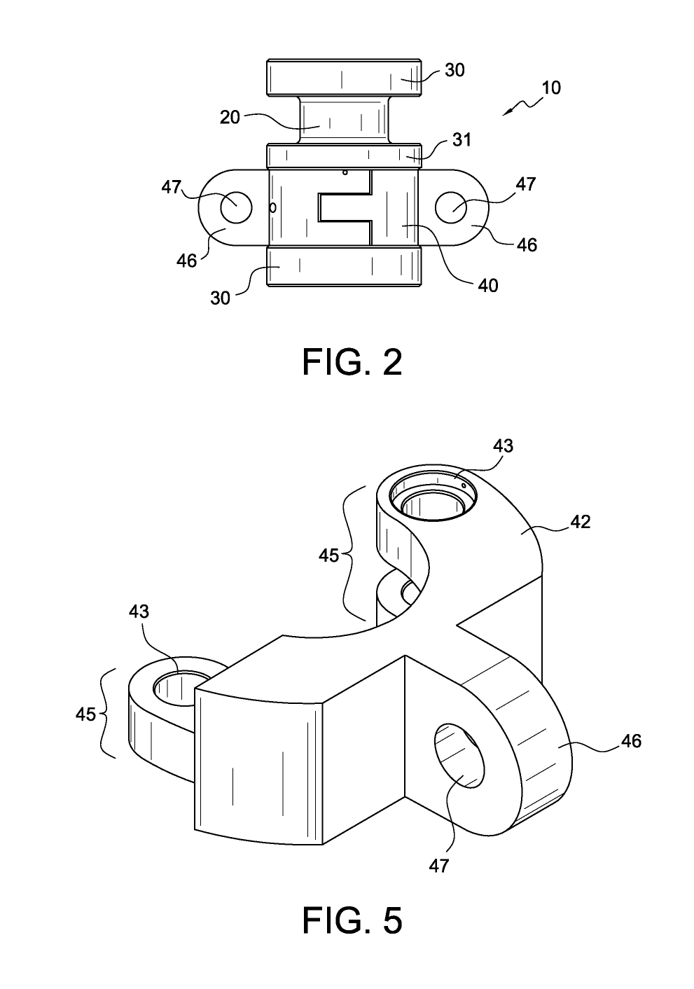

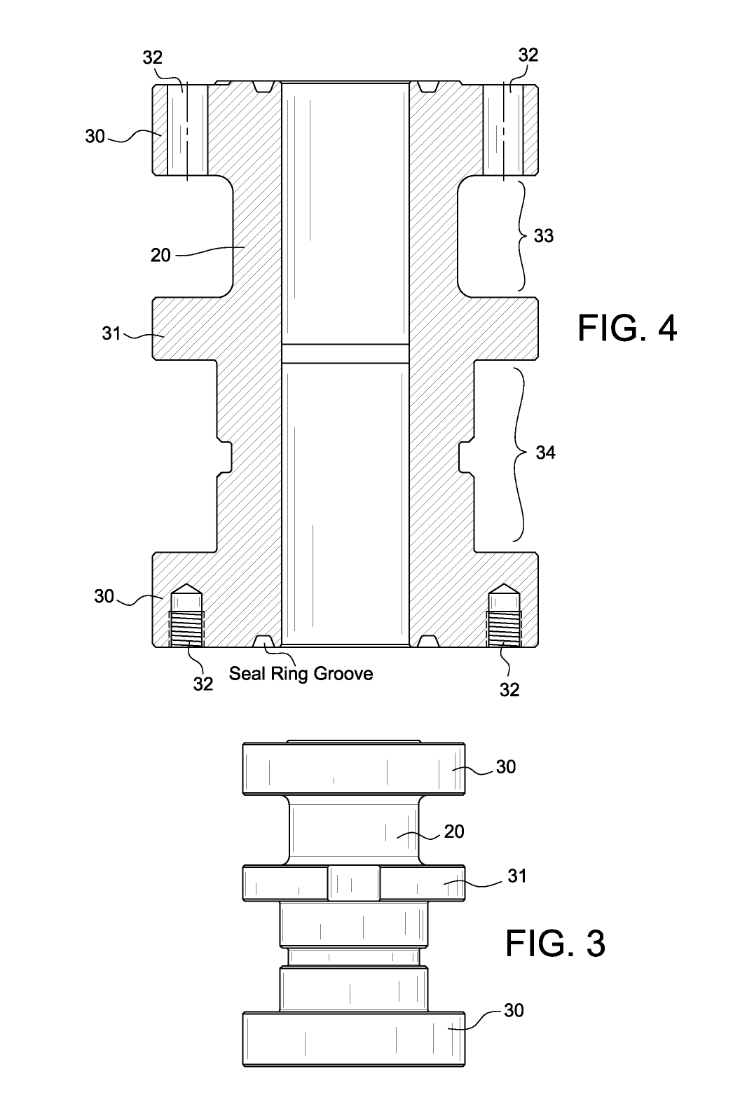

The encircling pull collar 40 preferably comprises two substantially identical, generally half-circle halves 42 and 44, as in FIG. 5. Referring to the other drawings, it can be readily understood that the two halves are placed around flanged spool 20, within one of the recessed areas 33 or 34 (in the drawings, the lower recessed area receiving the collar), and pins 50 (seen in FIG. 1) are inserted through holes 43 in mating ears 45, which can be readily understood to mesh together as seen in FIG. 1. It is understood that the inner diameter of pull collar 40 is somewhat larger than the diameter of the section of spool 20 around which it is placed, for example recessed section 34, so that pull collar can readily rotate on spool 20. If desired, one side of pull collar 40 can be pinned, effectively hinging pull collar halves together, then pull collar 40 can be placed around an intermediate section of spool 20 and the other side pinned together. As can be readily understood from this description, pull collar 40 is longitudinally restrained on spool 20, by the flanges, yet can rotate on spool 20.

Collar 40 comprises a means for attaching securing members thereto, such as cables and the like or rigid members. In a presently preferred embodiment, the means for attaching securing members comprises a plurality, in the illustrated embodiment two in number, of attachment lugs 46, each having holes 47 therein. As readily understood, lugs 46 and holes 47 provide a secure attachment point for cables, chains or other load bearing securing members to be attached, typically by means of a shackle arrangement.

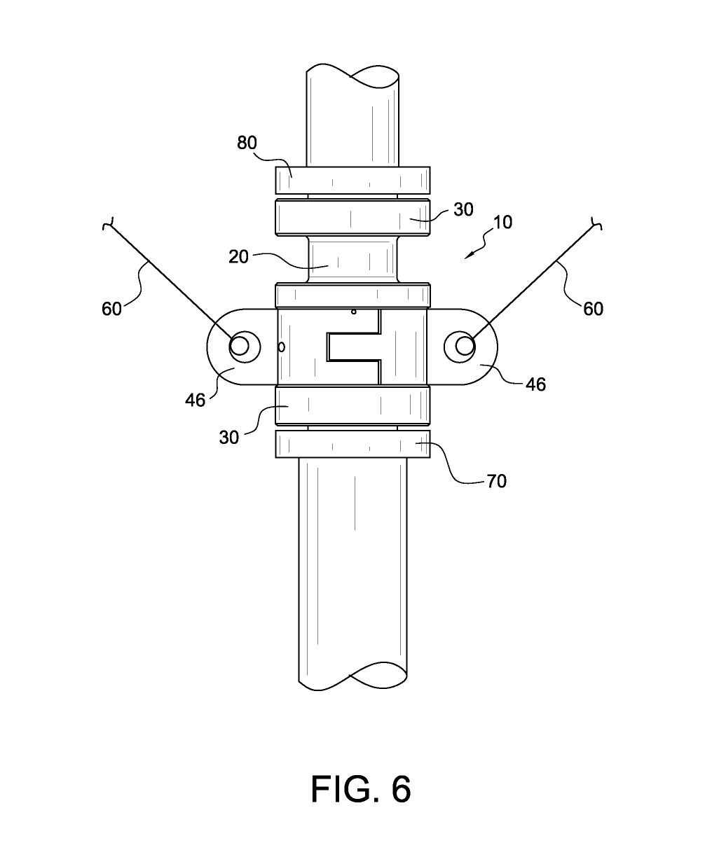

FIG. 6 shows an illustrative use of the present invention. Spool 20 is attached to another flanged component 70, such as a wellhead, and has another flanged component 80 attached to the upper end of spool 20. Cables 60 are run to a desired point which may be to anchor points to brace the structure, or may be to equipment attached atop the structure. It is understood that the present invention provides a secure attachment point for numerous purposes. Further, in view of the fact that collar 40 can rotate on spool 20, the direction of cables 60 and the like can be changed as desired.

Materials suitable for fabricating the various parts of the apparatus include high strength metals and metal alloys, as well known in the relevant art field.

### CONCLUSION

While the foregoing description sets out specificities regarding one presently preferred embodiment of the invention, it is to be understood that various changes may be made to the described embodiment while remaining within the scope of the invention. For example:
the spool may have only two flanges, with a single recessed area therebetween for the collar to mount; alternatively, the spool may have three or more recessed areas
more than one collar may be mounted in multiple recessed areas of the spool
the collar may be made of more than two segments (i.e. more than two segments making up a full circle)
cables, chains, ropes, or similar flexible securing members, or rigid securing members may be connected to the lugs on the collar
various materials may be used to fabricate the apparatus
dimensions may be varied to suit particular applications
the apparatus may be employed in a number of settings, wherever it is necessary or desirable to provide a means for securing a flanged member, such as in oil and gas well drilling and servicing.

Therefore, the scope of the invention is to be measured not by the illustrative examples given, but by the scope of the appended claims and their legal equivalents.

We claim:

1. Apparatus, comprising:
a spool comprising spaced apart end flanges, forming an recessed section therebetween having a diameter smaller than a diameter of said end flanges;
an openable collar, adapted to be placed around said recessed section of said spool and fastened thereon, whereby said collar is longitudinally restrained on said spool by said end flanges while capable of rotating on said spool, said collar comprising means for attaching securing members thereto.

2. The apparatus of claim 1, wherein said collar comprises two generally half-circle pieces, whereby said two half-circle pieces comprise mating ears having holes therein, whereby when said half-circle pieces are in place around said spool said mating holes are aligned for insertion of pins therethrough, thereby fastening said collar around said spool.

3. The apparatus of claim 1, wherein said means for attaching securing members comprises one or more attachment lugs formed in said half circle pieces.

4. The apparatus of claim 3, wherein said means for attaching cables comprises two attachment lugs, one each on opposing sides of said collar.

5. The apparatus of claim 2, wherein said means for attaching securing members comprises one or more attachment lugs formed in said half circle pieces.

6. The apparatus of claim 5, wherein said means for attaching securing members comprises two attachment lugs, one each on opposing sides of said collar.

7. An apparatus for stabilizing a tubular, comprising:
an elongated hollow spool comprising end flanges and a recessed section of smaller diameter than said end flanges, intermediate said end flanges;
an openable collar which fits around said recessed section of said spool, longitudinally restrained but capable of rotation therearound, with a means for attaching securing members thereto.

8. The apparatus of claim 7, wherein said spool further comprises an intermediate flange positioned between said end flanges, forming a pair of recessed sections between said intermediate flange and said end flanges, and wherein said collar fits into one of said recessed sections.

9. An apparatus for mounting on a flange and stabilizing a tubular and related equipment, comprising:
an elongated hollow spool comprising end flanges and a recessed section of smaller diameter than said end flanges, intermediate said end flanges;
an openable collar which fits around said recessed section of said spool, longitudinally restrained but capable of rotation therearound, with a means for attaching securing members thereto, the collar comprising two substantially identical half-circle halves, each of said halves comprising mating ears which fit together to form a circle, each of said halves comprising mating ears with holes therethrough,
whereby when said halves of said collar are fit around said recessed section, pins are inserted through said holes to lock said collar on said spool, and
wherein said collar comprises means for attaching securing members thereto.

10. The apparatus of claim 9, wherein said securing members are fastened to anchor points to stabilize said tubular and said related equipment.

11. The apparatus of claim 9, wherein said securing members are fastened to service equipment, to stabilize same atop said tubular.
